(19) United States
(12) Patent Application Publication
(10) Pub. No.: US 2026/0350563 A1
(43) Pub. Date: Nov. 5, 2026

(54) CONTROLLING TRANSFER OF STAKED BLOCKCHAIN TOKENS

(71) Applicant: Unstoppable Domains, Inc., Las Vegas, NV (US)

(72) Inventors: Matthew Gould, Atlanta, GA (US); Lisa Seacat DeLuca, Bozeman, MT (US)

(21) Appl. No.: 19/198,643

(22) Filed: May 5, 2025

(51) Int. Cl. G06Q 20/10

(52) U.S. Cl. CPC G06Q 20/10; G06Q 2220/00

(57) ABSTRACT

According to a present invention embodiment, a system acquires, for a value, an item for a user from a computerized platform of the computer environment. A first blockchain transaction is conducted to indicate acquisition of the item on a blockchain. Blockchain tokens are assigned to the item. An initial valuation of the blockchain tokens corresponds to a portion of the value and a valuation of the blockchain tokens fluctuates over time. A second blockchain transaction is conducted to indicate return of the item on the blockchain. Transfer of the blockchain tokens is controlled based on return of the item. Embodiments of the present invention further include a method and computer program product for transferring items in a computer environment in substantially the same manner described above.

### TECHNICAL FIELD

Present invention embodiments relate to networking and, more specifically, to controlling transfer of blockchain tokens with fluctuating (or continuously varying) values staked for an item (e.g., Web3 domain or domain name, blockchain domain or domain name, non-fungible token (NFT), asset of decentralized systems, Web2 domain or domain name, ICANN domain or domain name, Domain Name System (DNS) domain or domain name, physical or tangible item, virtual item, asset of centralized systems, etc.) based on return of the item.

### BACKGROUND

### Discussion of the Related Art

Web2 generally refers to a version of the web (or Internet) that utilizes a centralized Domain Name System (DNS) to translate domain names into corresponding Internet Protocol (IP) addresses in order to access a web site. In contrast, Web3 generally refers to a decentralized version of the web (or Internet) based on blockchains and peer-to-peer networks.

Domains may reside on Web2 and/or Web3. Web2 domains (e.g., ICANN domain or domain name, Domain Name System (DNS) domain or domain name, etc.) require periodic renewal fees (e.g., a yearly or other periodic renewal), while Web3 domains have explored various renewal models, such as staking or single-purchase lifetime ownership. Staking refers to a user enabling other users to register under the user top level domain (TLD) according to prices and terms specified by the user. However, these approaches for Web2 and Web3 domain renewals suffer from several disadvantages. For example, flat (or fixed) renewal fees do not incentivize owners to return unused Web2 or Web3 domains, thereby leading to squatting of these domains. Further, a one-time lifetime purchase eliminates recurring revenue for registrars of Web3 domains, and leads to less incentive for domain owners to relinquish Web3 domains no longer in use. Staking models primarily discount renewal fees or hold blockchain tokens in a vault for a Web3 domain, but do not leverage token appreciation (or growth in token value) to incentivize return of Web3 domains (e.g., when the token appreciation renders the return of the domain profitable).

### SUMMARY

According to one embodiment of the present invention, a system for transferring items in a computer environment comprises one or more memories and at least one processor coupled to the one or more memories. The system acquires, for a value, an item for a user from a computerized platform of the computer environment. A first blockchain transaction is conducted to indicate acquisition of the item on a blockchain. Blockchain tokens are assigned to the item. An initial valuation of the blockchain tokens corresponds to a portion of the value and a valuation of the blockchain tokens fluctuates over time. A second blockchain transaction is conducted to indicate return of the item on the blockchain. Transfer of the blockchain tokens is controlled based on return of the item. Embodiments of the present invention further include a method and computer program product (e.g., including one or more computer readable media with instructions executable by one or more processors) for transferring items in a computer environment in substantially the same manner described above.

### BRIEF DESCRIPTION OF THE DRAWINGS

Generally, like reference numerals in the various figures are utilized to designate like components.

FIG. 1 is a diagrammatic illustration of an example computing environment according to an embodiment of the present invention.

FIG. 2 is a block diagram of an example computing device according to an embodiment of the present invention.

FIG. 3 is a procedural flowchart of a method of registering a name or other identifier for an onchain asset (e.g., Web3, blockchain, etc.) based on a name or other identifier for an offchain asset (e.g., Web2, Domain Name System (DNS), etc.) according to an embodiment of the present invention.

FIG. 4 is a procedural flowchart of a method of controlling transfer of staked blockchain tokens according to an embodiment of the present invention.

FIG. 5 is a schematic illustration of an example user interface for acquiring an onchain and/or offchain domain according to an embodiment of the present invention.

FIG. 6 is a schematic illustration of an example user interface providing information for onchain and/or offchain domains according to an embodiment of the present invention.

### DETAILED DESCRIPTION

Web2 generally refers to a version of the web (or Internet) that utilizes a centralized Domain Name System (DNS) to translate domain names into corresponding Internet Protocol (IP) addresses in order to access a web site. Domain Name System (DNS) creates a set of one or more records when a domain name is registered. DNS records (or text files) reside in DNS servers and provide information pertaining to a domain name including an associated IP address and request handling.

In contrast, Web3 generally refers to a decentralized version of the web (or Internet) based on blockchains and peer-to-peer networks.

Marketplaces and brokerage services for (Web2 and/or Web3) domain names facilitate the transfer of the domain names. These platforms help connect owners of domain names with potential users interested in acquiring the domain names and manage the often complex and lengthy transfer process.

Marketplaces for (Web2 and/or Web3) domain names are online or computerized platforms where domain owners list their available domains, and prospective users interested in acquiring domains can search, negotiate, and acquire the domains. These marketplaces provide a transparent and centralized manner for connecting owners with prospective acquirers, and often offer tools that streamline the entire transaction process, including valuation guidance, escrow services, and actual transfer of the domain name.

Owners can list their (Web2 and/or Web3) domain names on these platforms and set a value or select an auction-style listing. Owners may also negotiate directly with interested users when the listing is auction-based. Interested users can browse available domains via keyword searches, category filters, or domain extensions. Marketplaces often provide domain valuation tools to help interested users understand the market value of a domain name.

Some marketplaces allow interested users to acquire domains immediately at a fixed value (typically in the case of premium domains). In other cases, marketplaces enable owners and interested users to negotiate the value, often involving an option for the interested user to provide an offer. The platforms may offer built-in valuation tools to help establish fair market values based on comparable domain transfers.

Web2 domains (e.g., ICANN domain or domain name, Domain Name System (DNS) domain or domain name, etc.) require periodic renewal fees (e.g., a yearly or other periodic renewal), while Web3 domains have explored various renewal models, such as staking or single-purchase lifetime ownership. Staking refers to a user enabling other users to register under the user top level domain (TLD) according to prices and terms specified by the user. However, these approaches for Web2 and Web3 domain renewals suffer from several disadvantages. For example, flat (or fixed) renewal fees do not incentivize owners to return unused Web2 or Web3 domains, thereby leading to squatting of these domains. Further, a one-time lifetime purchase eliminates recurring revenue for registrars of Web3 domains, and leads to less incentive for domain owners to relinquish Web3 domains no longer in use. Staking models primarily discount renewal fees or hold blockchain tokens in a vault for a Web3 domain, but do not leverage token appreciation (or growth in token value) to incentivize return of Web3 domains (e.g., when the token appreciation renders the return of the domain profitable).

Accordingly, an embodiment of the present invention provides an approach that requires staking (or assigning or locking) a certain amount (or value) of blockchain tokens (e.g., cryptocurrency, non-fungible tokens (NFTs), etc.) for Web2 and/or Web3 domain ownership. The stake of blockchain tokens encourages owners to return the domains since the value of the staked blockchain tokens is provided to the owner upon returning a domain (e.g., unlocks the staked blockchain tokens). In other words, the domain may be exchanged for the staked blockchain tokens. Further, the stake of blockchain tokens generates ongoing yield that can be provided for a domain registry or a community pool, thereby creating a sustainable revenue (or renewal) model. The staked blockchain tokens further naturally scale renewal cost with domain value since more valuable domains tend to have more blockchain tokens staked.

Moreover, the staked blockchain tokens encourage frequent and high standard use for the domains. For example, an owner of a domain not being used and with high blockchain token appreciation (or value growth) is incentivized to return the domain to receive the appreciated blockchain token value. Further, with respect to a domain in use that has substantially appreciated (substantial growth in value), the portion of the value of the domain appreciation that is for a registry is reflected in appreciation of the blockchain token value (e.g., the registry receives a portion or percentage of blockchain token value or yield), thereby providing a higher holding opportunity cost. Since the blockchain tokens are staked to domains (e.g., effectively serving as an exchange traded fund (ETF) of the domain space itself), when all the domains appreciate, the blockchain tokens appreciate and owners who hold valuable domains pay an effective higher cost rate on the domains (e.g., the registry receives a greater amount (or yield) due to the blockchain token appreciation).

In addition, the staked blockchain tokens enable long term owners to continue ownership of their domains even when the value of their domains significantly appreciates since blockchain tokens are provided in advance. Thus, a substantial increase in value of the blockchain tokens does not negatively impact the owner. Further, the owner is not subject to higher annual renewal fees.

An embodiment of the present invention incentivizes domain or other asset ownership using staked blockchain tokens for yield generation. The embodiment provides domain registration and maintenance on a blockchain-based domain platform through blockchain token staking. When a user acquires a domain, blockchain tokens having a value of a portion of the (or entire) payment is staked and locked with a smart contract for that domain (as long as the domain is not returned). When the domain is transferred to a new owner (e.g., available on a secondary marketplace), the blockchain tokens are still locked and remain assigned to the domain.

Upon relinquishment, the domain is sent or transferred to a designated blockchain return address that triggers the release of the staked blockchain tokens (appreciating or depreciating in value over time) back to the user (or current owner returning the domain). For example, a registry may receive the domain back to replenish inventory and re-sell. Thus, the blockchain tokens may remain locked indefinitely when the domain is in use and has high worth. Yield on the tokens (or value portion) may flow to a registry or community pool, thereby effectively functioning as a domain renewal fee.

An embodiment of the present invention encourages domain owners to release underutilized domains, thereby rendering them available for re-sale at potentially higher market prices. Further, domain values are aligned with the staked blockchain tokens, thereby creating a more equitable, value-based fee structure. Moreover, the present invention embodiment may create (or mint) a blockchain token representing domain name value (similar to an exchange traded fund (ETF)) which can be marketed to passive investors who desire exposure to domain name appreciation without having to manage a domain portfolio. In addition, an automatic renewal income stream is created via staking yield.

A present invention embodiment provides a scalable renewal model where high-value domains naturally provide larger staking amounts and, consequently, higher yield to support ongoing registry operations over time. Further, the present invention embodiment enables improved domain availability since domain owners are motivated to return or relinquish domains that are not actively used (in order to reclaim the staked blockchain tokens). This allows registries to re-sell these domains potentially at higher market prices.

A present invention embodiment may be applied to Web2 and/or Web3 domains. For example, DNS domain owners may leverage present invention embodiments without the need for a blockchain (or crypto) wallet to manage blockchain tokens associated with their domain names. Domain owners can relinquish domain ownership profitably when blockchain token value appreciates. Further, passive income for a registry/community is provided based on ongoing staking yield reducing reliance on one-time sales. In addition, automatic domain cycling is provided since domains re-enter the market once users return them, thereby providing increased availability and revenue opportunities.

A present invention embodiment fundamentally changes how domain (or other asset) ownership and/or renewal fees are handled on a blockchain-based registry. By tying the domain value to staked or locked blockchain tokens, domains effectively become self-renewing assets whose maintenance is paid from yield accrued on the staked blockchain tokens. Owners may reclaim the blockchain tokens when they no longer need the domain. This creates a more equitable, market-driven, and capital-efficient model for blockchain domain ownership.

Present invention embodiments may be extended to NFT-based assets beyond domains, thereby employing staked blockchain tokens to generate yield-based renewal or other fees. Further, oracles may be used to track blockchain token value in real time. This can enable advanced features, such as dynamic domain valuation. Moreover, present invention embodiments may accommodate various interests in the domains, such as domain renting or ownership. Blockchain tokens may be staked for a short-term rental or for a more extended timeframe for ownership.

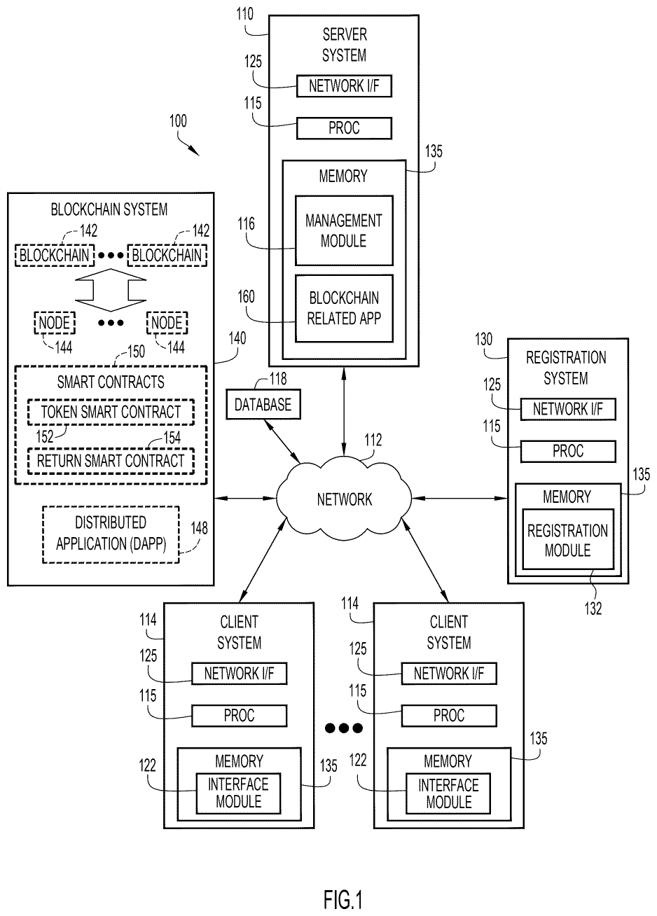

An example environment 100 for use with present invention embodiments is illustrated in FIG. 1. Specifically, environment 100 includes one or more server systems 110, one or more client or end-user systems 114, one or more registration systems 130, and one or more blockchain systems 140 each implementing and maintaining at least one corresponding blockchain 142. Server systems 110, client systems 114, registration systems 130, and/or blockchain systems 140 may be remote from each other and communicate over a network 112. The network may be implemented by any number of suitable communications media (e.g., wide area network (WAN), local area network (LAN), Internet, Intranet, etc.). Alternatively, server systems 110, client systems 114, registration systems 130, and/or blockchain systems 140 may be local to each other, and communicate via any appropriate local communication medium (e.g., local area network (LAN), hardwire, wireless link, Intranet, etc.).

Server systems 110 include a management module 116. Management module 116 may interface with a user via a client system 114, and/or may be of the form of an Application Programming Interface (API) to perform onchain and/or offchain asset management (e.g., for domains or other objects, marketplace or other platforms, etc.). The management module may process requests from any entities (e.g., user, application, service, computing or other device, etc.).

Client systems 114 may include an interface module 122 to provide a graphical user (e.g., GUI, etc.) or other interface (e.g., command line prompts, menu screens, etc.) that enables users to access server systems 110 and blockchain systems 140 for managing onchain and/or offchain assets (e.g., domains or other objects, etc.). The interface module may include any conventional or other browser to access server systems 110 and blockchain systems 140.

Registration systems 130 include a registration module 132 that registers and manages names or other identifiers for offchain assets (e.g., Web2 domains or domain names, ICANN domains or domain names, Domain Name System (DNS) domains or domain names, etc.). By way of example, the registration system may include a conventional or other DNS server and be associated with one or more registrars.

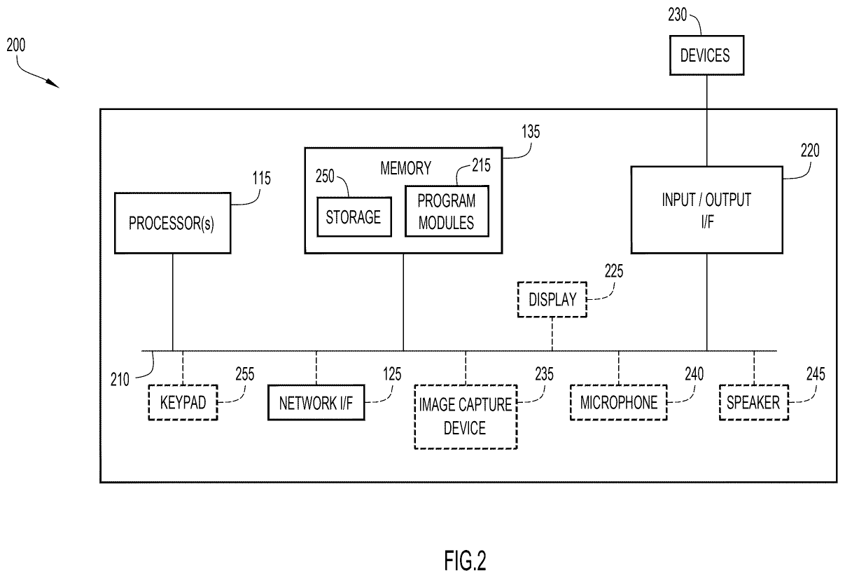

Blockchain systems 140 may each include one or more nodes 144 to implement and maintain at least one corresponding blockchain 142. The nodes may be implemented by any suitable computing devices (e.g., as described below for FIG. 2). The blockchain is generally in the form of a ledger that includes a series of records or blocks chained or linked together. The blockchain is typically managed by a peer-to-peer network (of nodes 144) and used as a distributed ledger. Nodes 144 of the peer-to-peer network communicate and verify new blocks according to a protocol. The peer-to-peer network provides a decentralized approach, where each node has a copy of a blockchain 142. Transactions are transmitted to the peer-to-peer network, where mining nodes (nodes 144) process the transactions. The mining nodes validate a transaction, insert the transaction into a current block, and transmit the block to the other nodes. Blockchain 142 may be implemented by any conventional or other blockchain, and may be a public (e.g., no access restrictions, etc.), private (e.g., restricted access, etc.), or hybrid (e.g., with centralized and decentralized features) blockchain.

Blockchain systems 140 may include one or more distributed or decentralized applications (dApps) 148 to perform various operations (e.g., financial or other transactions or operations related to a blockchain, etc.). In addition, a blockchain 142 may store software (e.g., typically referred to as smart contracts 150) that executes on the blockchain in response to occurrence of pre-defined conditions. The smart contracts include a token smart contract 152 to assign and manage blockchain tokens for onchain assets (and/or offchain assets), and a return smart contract 154 to process return of onchain assets (and/or corresponding offchain assets) and provide the assigned blockchain tokens to the user. The functions of token and return smart contracts 152, 154 may be performed by a single smart contract or by any quantity of individual smart contracts. In addition, smart contracts 150 may transfer onchain and/or offchain assets as described below. The onchain assets may be associated with the same and/or various different blockchains.

Interface module 122 of client systems 114 may further provide a graphical user (e.g., GUI, etc.) or other interface (e.g., command line prompts, menu screens, etc.) that enables users to access decentralized applications (dApps) 148 and/or smart contracts 150 on blockchain systems 140 for performing various operations (e.g., financial or other transactions or operations related to a blockchain, etc.). The interface module may include any conventional or other browser to access the decentralized applications (dApps) of blockchain systems 140. The interface module may natively, or include extensions to, access the decentralized applications (dApps) and/or other components of blockchain system 140. The interface module may provide a user interface to serve as a front end for a decentralized application (dApp) 148, where back end processing for the decentralized application (dApp) is performed on a blockchain system 140. Client systems 114 may further provide reports or notifications pertaining to requests from users (e.g., results of a transaction, transfers of onchain and/or offchain assets, etc.).

Server systems 110 further include one or more blockchain related applications 160 for performing various operations (e.g., transactions or operations related to a blockchain, access asset information based on an associated asset, etc.). Management module 116 and blockchain related applications 160 may be on the same or different server systems 110. The blockchain related application may process requests from any entities (e.g., user, application, service, computing or other device, etc.).

A database or offchain storage system 118 may store various information for a blockchain asset (e.g., blockchain asset information, mappings of blockchain assets to blockchains, blockchain domain content, etc.). The database system may be implemented by any conventional or other database or offchain storage unit (e.g., Interplanetary File System (IPFS), etc.), may be local to or remote from server systems 110, client systems 114, registration systems 130, and/or blockchain systems 140, and may communicate via any appropriate communication medium (e.g., local area network (LAN), wide area network (WAN), Internet, hardwire, wireless link, Intranet, etc.).

Server systems 110, client systems 114, and registration systems 130 may be implemented by any conventional or other computer systems preferably equipped with a display or monitor, a base, optional input devices (e.g., a keyboard, mouse or other input device), and any software for use by present invention embodiments (e.g., server/communications software, blockchain software, management module 116, interface module 122, registration module 132, blockchain related applications 160, etc.). The base may include at least one hardware processor 115 (e.g., microprocessor, controller, central processing unit (CPU), etc.), one or more memories 135, and/or internal or external network interfaces or communications devices 125 (e.g., modem, network cards, etc.)).

Management module 116, interface module 122, registration module 132, smart contracts 150, token smart contract 152, return smart contract 154, decentralized applications (dApps) 148, and blockchain related applications 160 may include one or more modules or units to perform the various functions of present invention embodiments described below. The various modules (e.g., management module 116, interface module 122, registration module 132, blockchain related applications 160, etc.) may be implemented by any combination of any quantity of software and/or hardware modules or units, and may reside within memory 135 of the server, client, registration, and/or offchain asset systems for execution by a corresponding processor 115. The various modules of the blockchain (e.g., decentralized applications (dApps) 148, smart contracts 150, token smart contract 152, return smart contract 154, etc.) may be implemented by any combination of any quantity of software and/or hardware modules or units, and may reside on a blockchain 142 for execution by one or more nodes 144.

An example of a computing device 200 for environment 100 (e.g., implementing server systems 110, client systems 114, registration systems 130, blockchain systems 140, nodes 144, etc.) is illustrated in FIG. 2. The example computing device may perform the functions of present invention embodiments described herein. Computing device 200 may be implemented by any personal or other type of computer or processing system (e.g., desktop, laptop, hand-held device, smartphone or other mobile device, etc.), and may be used for any computing environments (e.g., cloud computing, client-server, network computing, mainframe, stand-alone systems, etc.).

Computing device 200 may include one or more processors 115 (e.g., microprocessor, controller, central processing unit (CPU), etc.), network interface 125, memory 135, a bus 210, and an Input/Output interface 220. Bus 210 couples these components for communication, and may be of any type of bus structure, including a memory bus or memory controller, a peripheral bus, and a processor or local bus using any of a variety of conventional or other bus architectures. Memory 135 is coupled to bus 210 and typically includes computer readable media including volatile media (e.g., random access memory (RAM), cache memory, etc.), non-volatile media, removable media, and/or non-removable media. For example, memory 135 may include storage 250 containing non-removable, non-volatile magnetic or other media (e.g., a hard drive, etc.). The computing device may further include a magnetic disk drive and/or an optical disk drive (not shown) (e.g., CD-ROM, DVD-ROM or other optical media, etc.) connected to bus 210 via one or more data interfaces.

Moreover, memory 135 includes a set of program modules 215 (e.g., corresponding to management module 116, interface module 122, registration module 132, blockchain software (e.g., decentralized applications (dApp) 148, smart contracts 150, token smart contract 152, return smart contract 154, blockchain management software, etc.), blockchain related applications 160, network site or service software, etc.) that are configured to perform functions of present invention embodiments described herein. The memory may further include an operating system, at least one application and/or other modules, and corresponding data. These may provide an implementation of a networking environment.

Input/Output interface 220 is coupled to bus 210 and communicates with one or more peripheral or external devices 230 (e.g., a keyboard, mouse or other pointing device, a display, sensing devices, etc.), at least one device that enables a user to interact with computing device 200, and/or any device (e.g., network card, modem, etc.) that enables computing device 200 to communicate with one or more other computing devices. Computing device 200 may communicate with one or more networks (e.g., a local area network (LAN), a wide area network (WAN), a public network (e.g., the Internet), etc.) via network interface 125 coupled to bus 210.

With respect to certain entities (e.g., client system 114, etc.), computing device 200 may further include, or be coupled to, a touch screen or other display 225, a camera or other image capture device 235, a microphone or other sound sensing device 240, a speaker 245 to convey sound, and/or a keypad or keyboard 255 to enter information (e.g., alphanumeric information, etc.). These items may be coupled to bus 210 or Input/Output interface 220 to transfer data with other elements of computing device 200.

Initially, a blockchain (e.g., blockchain 142, etc.) is generally in the form of a ledger that includes a series of records or blocks chained or linked together. Each block includes a hash of the prior block in the blockchain, a timestamp, and transaction information. The hash of the prior block enables the blockchain to be resistant to modification since changes to data in any prior block alter the hash value which propagates to subsequent blocks.

A blockchain is typically managed by a peer-to-peer network and used as a distributed ledger. Nodes of the peer-to-peer network communicate and verify new blocks according to a protocol. The peer-to-peer network provides a decentralized approach, where each node has a copy of the blockchain. Transactions are transmitted to the network, where mining nodes process the transactions. The mining nodes validate a transaction, insert the transaction into a current block, and transmit the block to the other nodes. Various consensus approaches may be used for combining validation results of different mining nodes to determine validity of a transaction (or block).

Users of transactions for the blockchain are authenticated based on cryptographic keys. These keys identify a user and provide access to a user wallet. The user wallet is basically an application or software that enables users to store and access digital assets (e.g., for receiving or sending cryptocurrency or other fungible tokens, non-fungible tokens (NFTs), etc.). For example, a non-fungible token (NFT) is a crypto type asset with each token being unique (and representing items, such as digital art, music, or video game items), whereas fungible tokens (e.g., coins of the same cryptocurrency) have the same value of worth and are exchangeable. Each user is associated with their own private key (e.g., accessible only to the associated user, etc.) and a public key (e.g., typically an address on the blockchain). The private and public keys enable authentication of the user based on digital signatures in order to commence a transaction. The user wallet typically stores the private key.

For example, in order for the user to send cryptocurrency, a message for a transaction is encrypted (or signed) using the private key of the user wallet. The private key enables only the user to control the user wallet. A digital signature is created by encrypting the message with the private key, where the digital signature is used to verify the user and transaction. The message may be decrypted with the corresponding public key of the user wallet. Since the private key is unique to the user, successful decryption of the message with the corresponding public key verifies the message was sent by the user. Once verified, the transaction may be posted to the blockchain, thereby adjusting the user account based on the transaction.

In addition, a blockchain may store software (e.g., smart contracts 150) that executes in response to occurrence of pre-defined conditions. A smart contract is generally software or a program that runs on the blockchain. The code and data for the smart contract reside at a specific address on the blockchain. Non-fungible tokens (NFTs) are controlled by smart contracts that handle transference and verification of ownership of the non-fungible tokens (NFTs). A blockchain may be public (e.g., no access restrictions, etc.), private (e.g., restricted access, etc.), or hybrid (e.g., with centralized and decentralized features).

A blockchain domain name is stored on a blockchain. A blockchain domain name may be a non-fungible token (NFT) domain name that is associated with a non-fungible token (NFT) stored in a user wallet account. The blockchain domain name may be associated with various information (e.g., wallet addresses or accounts, user information (e.g., name, address, email, etc.), data or other access restrictions, etc.). The blockchain domain name is associated with software or smart contracts on the blockchain that may perform various functions (e.g., provide a registry for corresponding wallet addresses, indicate locations of content for the domain (e.g., or a website, etc.) hosted on the blockchain or other system, etc.). In order to access a blockchain domain, the blockchain is accessed to find the record corresponding to the blockchain domain name (which may initiate the corresponding smart contracts for the corresponding functionality). The private key of the user wallet enables the user to have sole control of the blockchain domain (e.g., authenticating operations or transactions for the blockchain domain name similar to the cryptocurrency example described above, etc.). For example, the user may have sole control to perform operations that alter content and/or functionality for the blockchain domain.

An embodiment of the present invention may be utilized for an online or computerized platform that allows users to acquire items (e.g., onchain and/or offchain domains or other assets, etc.). The embodiment provides domain registration and maintenance on a blockchain-based domain platform through blockchain token staking. When a user acquires a (Web2 and/or Web3) domain, blockchain tokens having a value of a portion of the (or entire) payment is staked and locked with a smart contract for that domain (as long as the domain is not returned). Upon relinquishment, the domain is sent or transferred to a designated blockchain return address that triggers the release of the staked blockchain tokens (appreciating or depreciating in value over time) back to the user (or current owner returning the domain). Yield on the blockchain tokens (or portion or percentage of the value) may flow to a registry or community pool, thereby effectively functioning as a domain renewal fee.

An asset may include any item or object, and may be associated with a computer or network environment (e.g., a domain, a domain name, a set of records, an object that points to a set of records, a non-fungible token (NFT), non-fungible token (NFT) domain names, a fungible token, a wallet address, email or other service, communication entity, currency, physical objects, virtual objects, etc.). An onchain asset may include any asset residing on, or supported by, a blockchain or other decentralized system (e.g., Web3 asset, asset of a decentralized system, asset of a partial or hybrid decentralized system, etc.). An offchain asset may include any asset residing on, or supported by, a centralized system or a system with centralized control (e.g., Web2, Domain Name System (DNS), ICANN accredited domain names, system other than a decentralized system described above, etc.). An offchain asset may further include any tangible or intangible objects maintained outside of a blockchain (e.g., currency, physical objects, virtual objects, etc.).

The online or computerized platform may list various items available for transfer (e.g., an onchain asset, an offchain asset, an item having a combination of onchain and offchain assets (e.g., a tokenized domain name and the corresponding offchain domain name, etc.), etc.).

Transfer of an onchain or offchain asset may include any action or transaction that provides ownership, rights, registration, custody, control, possession, and/or any other interest in the onchain or offchain asset. Further, acquiring or obtaining an onchain or offchain asset may include obtaining ownership, rights, registration, custody, control, possession, and/or any other interest in the onchain or offchain asset.

By way of example, an onchain asset may be a non-fungible token (NFT) representing a corresponding onchain version of an offchain domain name (or tokenized version of the offchain domain name). An offchain domain name (e.g., Web2 domain or domain name, ICANN domain or domain name, Domain Name System (DNS) domain or domain name, etc.) may be tokenized as an NFT or other onchain representation by a blockchain service or smart contract.

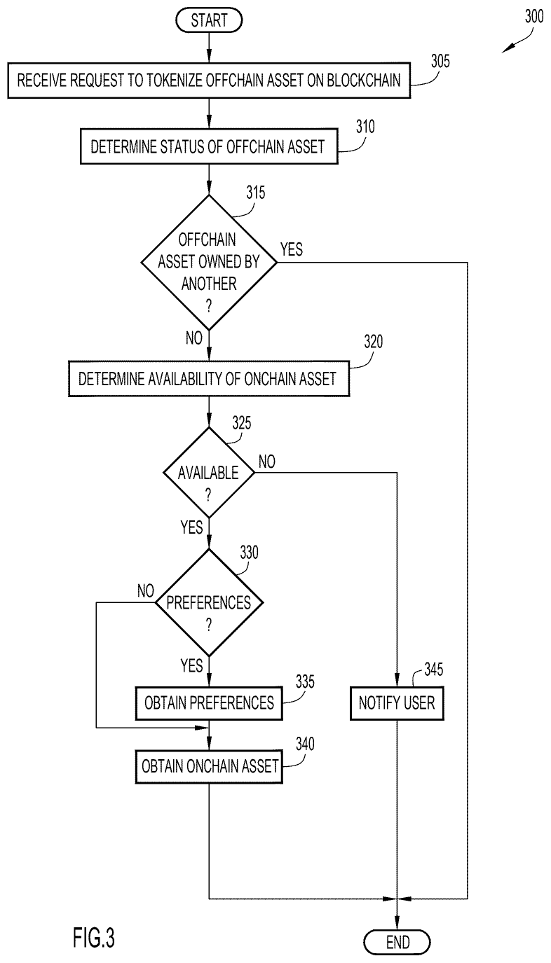

A method 300 of registering a name or other identifier for an onchain asset (e.g., Web3, blockchain, etc.) based on a name or other identifier for an offchain asset (e.g., Web2, Domain Name System (DNS), etc.) (e.g., via management module 116, registration module 132, decentralized application (dApp) 148, smart contract 150, blockchain related application 160, server system 110, client system 114, registration system 130, and/or blockchain system 140) according to an embodiment of the present invention is illustrated in FIG. 3. Initially, a user may register, or desire to register, a name or other identifier of an offchain asset (e.g., Web2, ICANN, Domain Name System (DNS), etc.) for an onchain asset (e.g., Web3, blockchain, non-fungible token (NFT), etc.) via management module 116. An asset may include any item or object, and may be associated with a computer or network environment (e.g., a domain, a domain name, a set of records, an object that points to a set of records, a non-fungible token (NFT), non-fungible token (NFT) domain names, a fungible token, a wallet address, email or other service, communication entity, currency, stocks, equities, physical objects, virtual objects, etc.). An onchain asset may include any asset residing on, or supported by, a blockchain or other decentralized system (e.g., Web3 asset, asset of a decentralized system, asset of a partial or hybrid decentralized system, etc.). An offchain asset may include any asset residing on, or supported by, a centralized system or a system with centralized control (e.g., Web2, Domain Name System (DNS), ICANN accredited domain names, system other than a decentralized system described above, etc.). An offchain asset may further include any tangible or intangible objects maintained outside of a blockchain (e.g., currency, physical objects, virtual objects, etc.). The name or other identifier for the offchain and onchain assets (e.g., with respect to NFTs and domains, etc.) may include a name portion and an optional extension (e.g., “name.e1”, etc.). Alternatively, the name or other identifier may include the name portion without the extension. The name portion and extension may each include any quantity of terms, words, tokens, or arrangements of any quantity of any types of elements (e.g., alphanumeric or other characters, symbols, numbers, etc.). A user may include, or be associated with, any type of entity (e.g., individual, company, organization, decentralized autonomous organization (DAO), etc.).

Management module 116 receives a request for the name or other identifier of the offchain asset to tokenize (or create a corresponding non-fungible token (NFT) for) the offchain asset on a blockchain at operation 305. The management module may receive and process requests from any entities (e.g., user, application, service, computing or other device, client system 114, etc.). The management module performs a look-up of the name of the offchain asset at operation 310 to determine registration/ownership of the offchain asset by another user (e.g., indicating unavailability of the offchain asset). By way of example, the offchain asset may include an offchain domain name (e.g., Web2, Domain Name System (DNS), etc.), and management module 116 requests information (e.g., DNS records, etc.) for the offchain domain name from registration system 130. The information from the registration system indicates registration/ownership or availability of the offchain asset.

When the offchain asset is not registered/owned by another user as determined at operation 315, management module 116 determines availability of the name of the offchain asset for an onchain asset at operation 320. In other words, management module 116 determines availability of an onchain representation of the offchain asset. For example, the management module (e.g., via blockchain related application 160) accesses an intended blockchain 142 for the onchain version (e.g., via a blockchain system 140), and performs a look-up for the name of the offchain asset on the blockchain. Absence of a record on the blockchain for the name indicates the name for the offchain asset (or onchain version) is available on the blockchain. Further, management module 116 may perform a look-up for the name (e.g., on a blockchain, marketplace, etc.) to determine availability of the onchain asset for transfer from another user. The intended blockchain may be selected by a user, and the name for the look-up may include the name portion of the name of the offchain asset (e.g., with the same extension, a corresponding extension for the intended blockchain, etc.).

When an onchain representation of the offchain asset is available as determined at operation 325, payment and other preferences may be provided or selected for acquiring the onchain version (e.g., tokenizing the offchain asset on the blockchain). The options or preferences may include payment to acquire the onchain representation, an intended blockchain or other system to publish or mint the onchain version, a smart contract for the transaction, etc. When preferences are required as determined at operation 330, management module 116 obtains the preferences at operation 335. The preferences may be stored offchain in database system 118, or received from an administrator.

The name for the onchain version is acquired at operation 340. For example, management module 116 (e.g., via decentralized application (dApp) 148, corresponding smart contract 150, and/or blockchain related application 160) publishes or mints the name for the onchain version (e.g., represented by a non-fungible token (NFT)) on a corresponding blockchain, and/or transfers the onchain asset from a current owner to the user (e.g., places the onchain asset in a user wallet account). The acquisition of the onchain version may be performed based on any required preferences. This may be accomplished by management module 116 (e.g., via decentralized application (dApp) 148, corresponding smart contract 150, and/or blockchain related application 160) providing a transaction to the blockchain indicating acquisition of the onchain version (or NFT) by the user. In addition, various information for the onchain version (e.g., user information, asset information, wallet information, etc.) may be stored onchain and/or in offchain storage (e.g., database system 118, etc.).

The offchain and onchain versions may be linked based on the name or other identifier. For example, management module 116 (e.g., via registration module 132 of registration system 130) may set a record associated with the offchain asset to indicate the onchain representation. By way of example, a Domain Name System (DNS) canonical name or other record may be created or modified to include an identifier for the onchain asset (e.g., onchain domain name, wallet address, etc.).

Further, management module 116 (e.g., via decentralized application (dApp) 148 and/or blockchain related application 160) may set or update records associated with the onchain asset to indicate information for the offchain asset. For example, an onchain or offchain record may be created or modified to include an identifier for the offchain asset (e.g., an offchain domain name to be linked, IP address, registry, etc.).

Once the onchain and offchain representations are acquired, transactions may be conducted (e.g., via management module 116 and/or blockchain related application 160) using the names for the onchain or offchain assets. For example, the information in the records for the offchain domain may be used to resolve data for the onchain representation (e.g., a user may send cryptocurrency to an offchain domain (based on an associated record indicating the onchain domain), etc.). The transaction may be analyzed to determine the actions, underlying system, and the corresponding representation needed for that system. By way of example, when the transaction is for an onchain representation (or domain) for an onchain system using an offchain representation (or domain), a lookup of the Domain Name System (DNS) canonical name or other record associated with the offchain representation (e.g., Web2/offchain/DNS version of the onchain domain) is performed to obtain the onchain representation for conducting the transaction. A similar approach may be used for offchain transactions using onchain representations.

Further, transactions conducted for an onchain or offchain representation may automatically be applied to the linked (offchain or onchain) representation. By way of example, selling an offchain representation also sells the linked onchain representation (and vice versa), transferring the onchain representation also transfers the linked offchain representation (and vice versa), making available for auction the onchain representation also makes the linked offchain representation available (and vice versa), purchasing an offchain representation brand new also purchases the linked onchain representation (and vice versa), taking out a loan may apply to the linked representations or be conducted using one of the linked representations, extending expiration of (or renewing) an offchain representation extends (or renews) the registration for a linked onchain representation (and vice versa), and/or transferring an offchain domain to a new registrar (in the case of domains) transfers the onchain domain to the new registrar (or vice versa) or the transfer may be conducted using one of the linked representations.

When the onchain asset is not available based on the look-up (e.g., an onchain representation of the offchain asset is already owned by the user or by another user that is not making the onchain asset available for transfer) as determined at operation 325, management module 116 alerts or notifies the user at operation 345. The notification may indicate ownership information for the onchain version of the offchain asset (e.g., the user or other user owning the onchain asset, etc.), and may be presented on a client system 114 (e.g., via interface module 122, etc.).

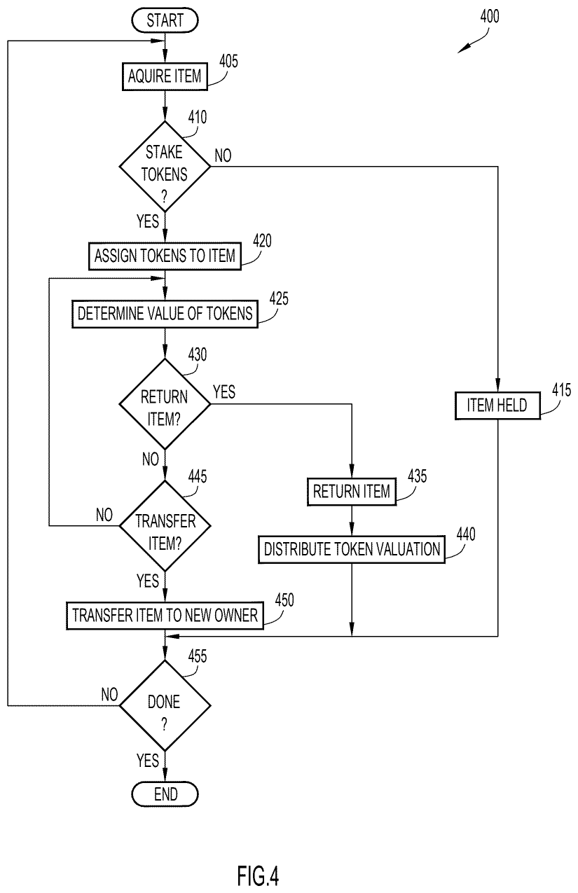

A method 400 of controlling transfer of staked blockchain tokens (e.g., via management module 116, registration module 132, decentralized application (dApp) 148, token smart contract 152, return smart contract 154, blockchain related application 160, server system 110, client system 114, registration system 130, and/or blockchain system 140) according to an embodiment of the present invention is illustrated in FIG. 4. Initially, items are listed on a computerized platform (e.g., marketplace, etc.), and an acquiring user acquires a listed item at operation 405. For example, the item may include an onchain asset (e.g., non-fungible token (NFT), NFT representing an offchain asset, etc.), an offchain asset (e.g., Web2, ICANN, or Domain Name System (DNS) domain or domain name, physical or tangible objects, virtual objects, etc.), or a combination of onchain and offchain assets (e.g., a tokenized version of an offchain domain name and the corresponding offchain domain name, etc.).

By way of example, the item may include an onchain domain (e.g., non-fungible token (NFT) (or blockchain) domain, an NFT representing an offchain domain (e.g., a tokenized version of the offchain domain), etc.), an offchain domain (e.g., Web2, ICANN, or Domain Name System (DNS) domain or domain name, etc.), or a combination of onchain and offchain domains (e.g., a tokenized version of an offchain domain name and the corresponding offchain domain name, etc.). However, an item may include any onchain and offchain assets used in substantially the same manner described below.

The acquisition of the item may be performed by management module 116. The acquiring user initially provides a payment (e.g., cryptocurrency, non-fungible token (NFT), etc.) to acquire the item (e.g., tenders a registration and/or other fee, etc.). For example, the transfer of the payment (e.g., cryptocurrency, non-fungible tokens (NFTs), etc.) may be accomplished by providing a transaction to the corresponding blockchain in substantially the same manner described above (FIG. 3). By way of example, management module 116 (e.g., via decentralized application (dApp) 148, smart contracts 150, and/or blockchain related application 160) transfers the payment (e.g., cryptocurrency, NFT, etc.) from a wallet account of the acquiring user to a wallet account associated with an offering entity of the item (e.g., current owner or user, a service provider of the platform, etc.).

Cryptocurrency may be hidden from the user to enable the user to tender the payment using offchain techniques (e.g., credit card, bank account, etc.) rather than cryptocurrency. In this case, the payment is converted to the appropriate blockchain tokens (or cryptocurrency) to be staked for the item. Thus, a user without a blockchain or crypto wallet may acquire the item. For example, an onchain asset of the item may be stored in a wallet account (of the platform service provider or other entity) associated with the user.

Once the payment is transferred, the item (e.g., including onchain and/or offchain versions) is transferred to the acquiring user. When the item includes an onchain domain (e.g., blockchain domain, tokenized domain name, etc.), the transfer may be accomplished by providing a transaction to the corresponding blockchain in substantially the same manner described above (FIG. 3). This effectively indicates ownership of the onchain asset (and any corresponding offchain asset) by the acquiring user.

For example, management module 116 (e.g., via decentralized application (dApp) 148, smart contract 150, and/or blockchain related application 160) transfers the domain to the acquiring user (e.g., places the onchain version in a wallet account of the acquiring user). This may be accomplished by management module 116 (e.g., via decentralized application (dApp) 148, smart contract 150, and/or blockchain related application 160) providing a transaction to the blockchain indicating acquisition of the onchain domain (or NFT) by the acquiring user. In addition, various information for the onchain version (e.g., acquiring user information, asset information, wallet information, etc.) may be stored onchain and/or in offchain storage (e.g., database system 118, etc.).

In the event the item includes an offchain domain (e.g., Web2 or DNS domain name, Web2 or DNS domain name corresponding to the onchain asset, etc.), management module 116 may transfer the offchain domain to the acquiring user (e.g., via registration module 132 of registration system 130). By way of example, management module 116 may send a request to registration module 132 of registration system 130. The request may indicate to edit or modify DNS or other records for the offchain domain of the item at a current registrar to transfer the offchain domain of the item to the user (using the same registrar).

Alternatively, a request for the offchain domain of the item to be transferred (to a new registrar) may be sent from registration system 130 to client system 114 of the prior user. The prior user performs the transfer process (e.g., with respect to unlocking and authorization codes) for management of the offchain domain of the item in a new registrar. The offchain domain of the item may be transferred to a registrar of choice of the acquiring user. The contact information (for the acquiring user) may be required as part of the transfer process for the offchain domain of the item and provided by the acquiring user (via client system 114) to registration system 130.

When blockchain tokens are not to be staked for the item as determined at operation 410 (e.g., via a parameter or setting indicating a current offering entity lists the item for transfer without requiring staking blockchain tokens, etc.), the item is held or maintained by the acquiring user at operation 415. In this case, the acquiring user cannot leverage the benefits or value of staked blockchain tokens as described below.

When blockchain tokens are to be staked for the item as determined at operation 410 (e.g., via a parameter or setting indicating a current offering entity lists the item for transfer requiring staking blockchain tokens, etc.), a portion of (or entire) payment from the acquiring user is staked (or assigned or locked) to the item at operation 420 via token smart contract 152 associated with the item. For example, the token smart contract may be associated with an NFT being, or representing, an onchain asset of the item, an NFT representing an offchain asset of the item, etc. The payment may include appropriate blockchain tokens (e.g., cryptocurrency, NFTs, etc.) that are directly staked. Alternatively, the payment may be converted to appropriate blockchain tokens, or new tokens may be minted, that are staked. The payment may be apportioned to cover various fees (e.g., a platform fee, ICANN/network fee, renewal fee, etc.). The staked blockchain token amount is locked in token smart contract 152 associated with the item (via a wallet account of the platform service provider or other entity).

Token smart contract 152 locks the staked blockchain tokens to the item. In other words, the staked blockchain tokens remain locked (or assigned) to token smart contract 152 associated with the item. The acquiring user cannot redeem or reclaim the staked blockchain tokens unless the acquiring user returns the item (e.g., associated NFT) to a blockchain return address. The locking may be accomplished by providing a transaction to the corresponding blockchain in substantially the same manner described above (FIG. 3). For example, token smart contract 152 transfers the staked blockchain tokens to the associated wallet account (of the platform service provider or other entity) (e.g., places the staked blockchain tokens in a wallet account associated with the item (or platform service provider or other entity)). This may be accomplished by token smart contract 152 providing a transaction to the blockchain indicating acquisition of the staked blockchain tokens by the associated wallet account.

Token smart contract 152 further calculates yield for (or a portion or percentage of) the staked blockchain tokens, and distributes the yield to the platform service provider (e.g., registrar, etc.) or a community pool. A fee may be charged for entities to join the community pool. This distribution may be accomplished by providing a transaction to the corresponding blockchain to transfer the yield to corresponding wallet (or crypto) accounts of the platform service provider and/or community pool members. The yield may be set to any desired portion or percentage of the quantity or value of the staked blockchain tokens.

Token smart contract 152 further determines a value for the staked blockchain tokens at operation 425. The value typically fluctuates, and the valuation of the staked blockchain tokens may be performed using any conventional or other valuation tools or techniques. By way of example, the valuation may be determined based on a current value of cryptocurrency (or other fungible tokens) and/or a predicted valuation of non-fungible tokens (NFTs). The value of the cryptocurrency may be ascertained based on information from various data sources (e.g., conventional or other network sites providing cryptocurrency values, etc.). For example, the valuation may be determined via any conventional or other tools or techniques (e.g., onchain protocols, staking platforms, etc.). Further, oracles may be used to track blockchain token value in real time. This can enable advanced features, such as dynamic domain valuation, and real time updates of the blockchain token valuation on user interfaces.

When blockchain tokens are staked for items, the user does not earn any value from the staked blockchain tokens (until the item is returned). However, a platform service provider (and/or community pool) earns value due to the yield being provided to the platform service provider. Since the yield is provided to the platform service provider, this serves as a deterrent to prevent an acquiring user from cyber squatting (e.g., the acquiring user would lose the yield on a domain that is not being used).

The value of any staked non-fungible tokens (NFTs) may be determined via any conventional or other tools or techniques. For example, the value of any staked non-fungible tokens (NFTs) may be ascertained from the purchase price and/or based on value information from various conventional or other marketplaces or other computerized platforms (e.g., floor prices (e.g., minimum offer or requested price, etc.) for the NFTs, prices for NFTs from their NFT communities, etc.). The staked non-fungible tokens (NFTs) may be redeemed or reclaimed when the acquiring user returns the item as described below.

When the item is to be returned as determined at operation 430 (e.g., based on a return or transfer actuator on a user interface), the item (or associated NFT) is transferred or sent to a blockchain return address (or special crypto wallet address of the platform service provider) operation 435. The blockchain return address may be hidden from the acquiring user when the platform (or registry) initiates or performs the return. The transfer may be accomplished by providing a transaction to the corresponding blockchain in substantially the same manner described above (FIG. 3). For example, management module 116 (e.g., via decentralized application (dApp) 148, return smart contract 154, and/or blockchain related application 160) transfers the item to the blockchain return address (e.g., places the item (or associated NFT) in a wallet account associated with the blockchain return address (or platform service provider)). This may be accomplished by management module 116 (e.g., via decentralized application (dApp) 148, return smart contract 154, and/or blockchain related application 160) providing a transaction to the blockchain indicating acquisition of the domain (or NFT) by the blockchain return address (or wallet account associated with the platform service provider). In addition, various information for the item (e.g., user information, asset information, wallet information, etc.) may be stored onchain and/or in offchain storage (e.g., database system 118, etc.).

In the event the item includes an offchain version (e.g., Web2 or DNS domain name, Web2 or DNS domain name corresponding to the onchain asset, etc.), management module 116 may transfer the offchain version to the offering entity, or suspend the offchain version (e.g., via registration module 132 of registration system 130). By way of example, DNS or other records may be modified to indicate a new Web2 domain owner, or to suspend the domain.

Return smart contract 154 verifies ownership and processes release of the staked blockchain tokens from the wallet account (of the platform service provider) associated with the item at operation 440. For example, this mechanism incentivizes relinquishing unused or less valuable domains. In this case, the domain state resets, thereby allowing the platform (or registry) to list the domain on the platform as available for transfer. The transfer may be accomplished by providing a transaction to the corresponding blockchain in substantially the same manner described above (FIG. 3). For example, return smart contract 154 transfers the staked blockchain tokens to the wallet account of the user returning the item (e.g., places the staked blockchain tokens in a wallet account associated with the user returning the item). This may be accomplished by return smart contract 154 providing a transaction to the blockchain indicating acquisition of the staked blockchain tokens by the wallet account associated with the user returning the item.

In the case the user does not have a wallet or crypto account on the blockchain, the blockchain tokens are converted to offchain currency and provided to the user returning the item (e.g., a bank account, a credit card, etc.). Thus, a user without a blockchain or crypto wallet may redeem the staked blockchain tokens.

When the user desires to transfer the domain to an acquiring user as determined at operation 445, token smart contract 152 automatically transfers the right to the staked blockchain tokens and the item to the acquiring user at operation 450. For example, the staked blockchain tokens move with the item automatically, thereby ensuring the acquiring user is the party whose staked blockchain tokens back the item. The acquiring user can view the locked blockchain tokens, but the only way to obtain the locked blockchain tokens is to return the item.

Alternatively, the domain and staked tokens may be released and one or more new blockchain tokens may be created or minted to serve as the staked blockchain tokens. The platform service provider may receive a fee from the payment and/or staked blockchain tokens.

The acquiring user initially provides a payment (e.g., cryptocurrency, non-fungible token (NFT), etc.) to acquire the item. For example, the transfer of the payment (e.g., cryptocurrency, non-fungible tokens (NFTs), etc.) may be accomplished by providing a transaction to the corresponding blockchain in substantially the same manner described above (FIG. 3). By way of example, management module 116 (e.g., via decentralized application (dApp) 148, smart contracts 150, and/or blockchain related application 160) transfers the payment (e.g., cryptocurrency, NFTs, etc.) from a wallet account of the acquiring user to a wallet account associated with the user.

Once the payment is transferred, the item (e.g., including onchain and/or offchain versions) is transferred to the acquiring user. In case of an onchain domain (e.g., blockchain domain, tokenized domain name, etc.), the transfer may be accomplished by providing a transaction to the corresponding blockchain in substantially the same manner described above (FIG. 3). For example, management module 116 (e.g., via decentralized application (dApp) 148, smart contracts 150, and/or blockchain related application 160) transfers the onchain domain to the acquiring user (e.g., places the onchain version in a wallet account of the acquiring user). This may be accomplished by management module 116 (e.g., via decentralized application (dApp) 148, smart contract 150, and/or blockchain related application 160) providing a transaction to the blockchain indicating acquisition of the onchain domain (or NFT) by the acquiring user. In addition, various information for the onchain version (e.g., user information, asset information, wallet information, etc.) may be stored onchain and/or in offchain storage (e.g., database system 118, etc.).

In the event of an offchain domain (e.g., Web2 or DNS domain name, Web2 or DNS domain name corresponding to the onchain asset, etc.), management module 116 may transfer the offchain domain to the acquiring user (e.g., via registration module 132 of registration system 130). By way of example, management module 116 may send a request to registration module 132 of registration system 130. The request may indicate to edit or modify DNS or other records for the offchain domain of the item to transfer the offchain domain.

Alternatively, a request for the offchain domain of the item to be transferred (to a new registrar) may be sent from registration system 130 to client system 114 of the prior user. The prior user performs the transfer process (e.g., with respect to unlocking and authorization codes) for management of the offchain domain of the item in a new registrar. The offchain domain of the item may be transferred to a registrar of choice of the acquiring user. The contact information (for the acquiring user) may be required as part of the transfer process for the offchain domain of the item and provided by the acquiring user (via client system 114) to registration system 130.

When the user does not desire to return or transfer the item as determined at operations 430, 445, the above process repeats from operation 425 to continuously determine (or update) the valuation for the staked blockchain tokens. The updated valuation may be presented on a user interface of the computerized platform or marketplace (e.g., in real time, etc.) as described below.

When the item is held at operation 415, the staked blockchain tokens are distributed for a returned item at operation 440, or the item is transferred at operation 450, the above process repeats from operation 405 until the item acquisitions are processed as determined at operation 455.

The yield generated from the staked blockchain tokens is provided to a registry-managed or community-managed pool, thereby effectively serving to provide a domain or other asset renewal cost. For example, a staked blockchain token requirement may waive (or provide payment for) the renewal fee. This automatically maintains the domain in force or use.

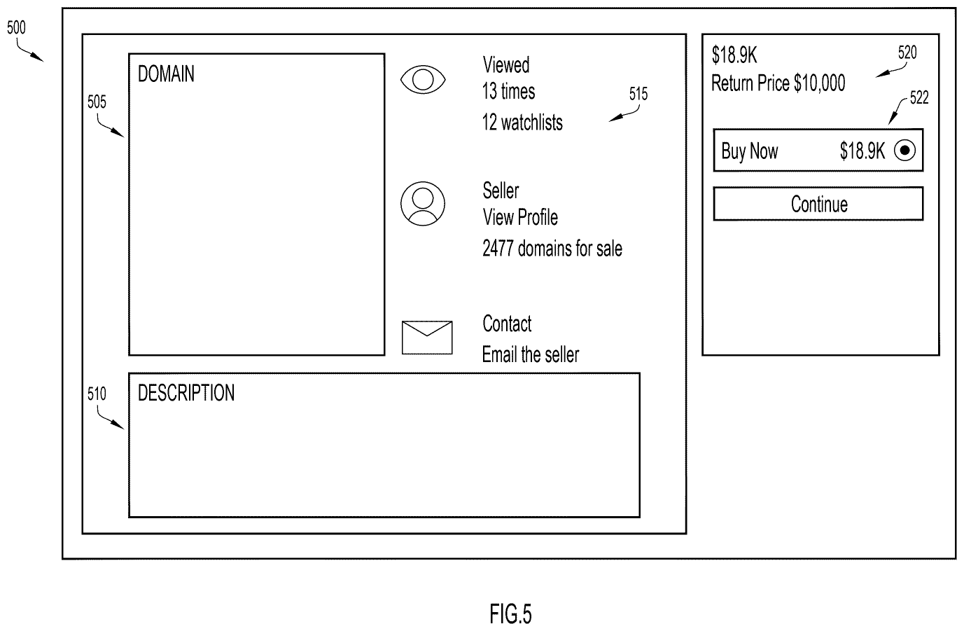

An example user interface 500 for acquiring a domain according to an embodiment of the present invention is illustrated in FIG. 5. Initially, an acquiring user navigates (via a client system 114) to a user interface of a computerized platform (managed by management module 116) providing available items including onchain and/or offchain domains. However, any onchain and/or offchain assets may be presented in substantially the same manner described below.

The acquiring user may select a domain (e.g., Web2 and/or Web3 domain) from the platform to present user interface 500 providing domain information. User interface 500 includes a domain area 505, a description area 510, an activity area 515, and an acquisition area 520. Domain area 505 may include an image or other information for the domain, while description area 510 provides a description for the domain. Activity area 515 includes activity information, such as a seller profile and contact information, and quantity of views for the domain. Acquisition area 520 indicates a value to acquire the domain, a return value (or value of the staked blockchain tokens) provided when the domain is returned, and actuators 522 to initiate acquisition of the domain (e.g., buy now and continue actuators as viewed in FIG. 5).

The return value (or value of staked blockchain tokens) is presented on user interface 500 to provide an indication to the acquiring user of the domain worth upon return relative to transference to another user. The valuation of the staked blockchain tokens may be updated on user interface 500 in real time. In this example case, the domain may be returned for $10k or sold for $18.9k. When the acquiring user decides to transfer the domain, the new user would have $10k in staked blockchain tokens for this domain. The information of user interface 500 may be presented within a domain management page or a portfolio valuation dashboard.

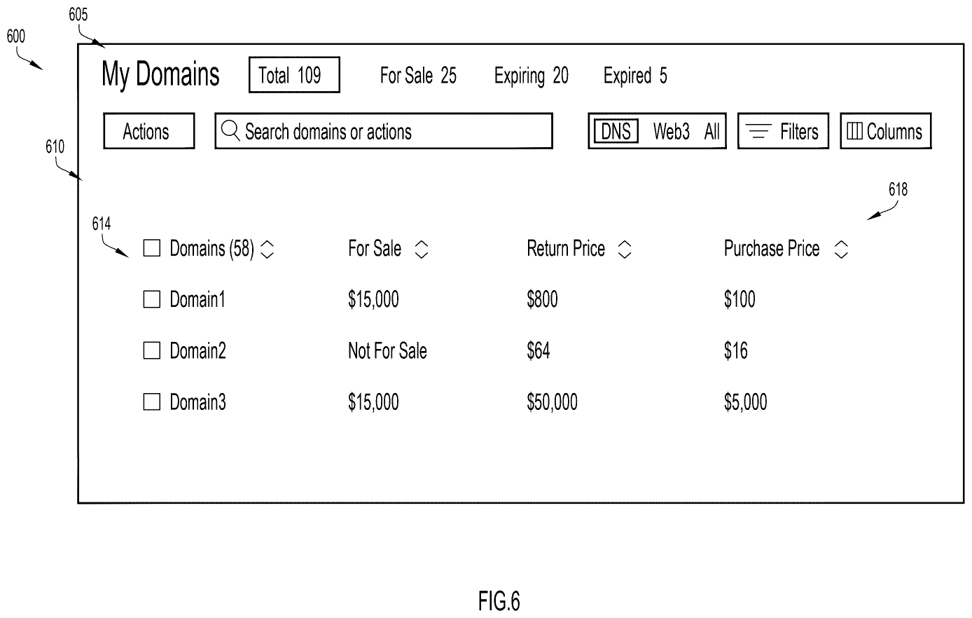

An example user interface 600 providing information for onchain and/or offchain domains according to an embodiment of the present invention is illustrated in FIG. 6. User interface 600 of the computerized platform presents a header area 605 and available onchain and/or offchain domains in the form of a table 610. However, any onchain and/or offchain assets may be presented in substantially the same manner described below. Header area 605 indicates domain information, such as total domains, a quantity of domains for sale, a quantity of expiring domains, and a quantity of expired domains. Header 605 may further include actuators to display types of domains (e.g., DNS, Web3, all domain types, etc.), filter domains, and specify columns.

Table 610 includes rows 614 each corresponding to a domain, and columns 618 each corresponding to an attribute or field for the domains of the rows. By way of example, rows 614 correspond to domains (e.g., Web2 and/or Web3 domains) DOMAIN1, DOMAIN2, and DOMAIN3 (as viewed in FIG. 6), while columns 618 may include a domain field, a sale price field, a return price field, and a purchase price field. The domain field indicates the domain name, while the sale price field indicates the price to acquire the domain. The return price indicates the value provided upon return of the domain, while the purchase price indicates the price the current acquiring user (or owner) tendered for the domain.

By way of example, a user acquires DOMAIN3 for $5,000 worth of blockchain tokens. Cryptocurrency may be hidden from the user to enable the user to tender the payment using offchain techniques (e.g., credit card, bank account, etc.) rather than cryptocurrency. In this case, the payment is converted to the appropriate blockchain tokens (or cryptocurrency) to be staked for DOMAIN3. The blockchain tokens are locked by token smart contract 152 associated with DOMAIN3 (or the associated NFT).

The blockchain tokens appreciate over time, and may grow to ten times the initial value, or $50,000. The yield for DOMAIN3 may be 7%, thereby providing $3,500 (e.g., $50,000×0.07=$3,500) to the platform service provider or a community pool. Effectively, DOMAIN3 is incurring $3,500/year for renewal or usage fees. This cost is invisible to the acquiring user in terms of direct payment, but the acquiring user is foregoing this amount on their own blockchain tokens and benefits from owning forever.

When DOMAIN3 is less valuable or the acquiring user decides to obtain the return value, the acquiring user returns DOMAIN3 (or associated NFT) to the blockchain return address and receives the value of the staked blockchain tokens ($50,000). The platform service provider may list DOMAIN3 for a new price, capturing additional revenue. For example, the sale price of $15,000 for DOMAIN3 is less than the return price ($50,000), and may be visually indicated (e.g., with an error color, font, underline, bold, asterisk, other visual indicator, etc.). The acquiring user may have listed DOMAIN3 for $15,000 believing this price would triple their original investment ($5,000). However, the staked blockchain tokens actually exceeded the listed price with a current valuation of $50,000. Therefore, the acquiring user should either return DOMAIN3 or increase the sale price to be greater than $50,000.

By way of further example, an acquiring user acquires DOMAIN1 for $100 with $80 of blockchain tokens being staked to token smart contract 152 associated with DOMAIN1. The remaining $20 may be provided to the platform service provider as a sunk purchase price. The value of the staked blockchain tokens appreciates significantly over time (e.g., to $800). In this case, the acquiring user can return DOMAIN1 in exchange for the new higher value (e.g., $800) of the staked blockchain tokens. DOMAIN1 reverts to the platform service provider which can re-sell DOMAIN1 at a current market price.

Present invention embodiments may provide various technical and other advantages, and solutions to problems rooted in computer technology. For example, present invention embodiments provide enhanced manners of accessing an asset, and enable use of asset identifiers (and access of corresponding assets) across different networks (e.g., DNS and blockchain, etc.). Present invention embodiments enable transactions using any of the corresponding offchain and onchain identifiers or domain names, thereby providing new functionality to an identifier of a network that is absent on that network (e.g., send cryptocurrency to a centralized or Web2 domain name, etc.). For example, an acquiring user may provide an onchain domain to connect to or access an offchain account, and an offchain domain to connect to or access a wallet account.

Further, an acquiring user without a blockchain or crypto wallet cannot typically conduct blockchain transactions. However, present invention embodiments enable an acquiring user without a blockchain or crypto wallet to conduct blockchain transactions (e.g., tender offchain payment and acquire onchain and/or offchain assets) from an onchain platform. This leverages and provides blockchain capabilities for offchain users.

Moreover, present invention embodiments provide enhanced security for blockchain items. For example, blockchain tokens (e.g., newly generated or minted, transferred from a user, etc.) may be locked or linked to an onchain and/or offchain asset. In this case, transfer of the blockchain tokens are restricted to the current user who has acquired the asset. For example, even though an initial user may provide the blockchain tokens, the blockchain tokens remain locked to the asset as the asset is transferred. In this case, the initial user loses access to the blockchain tokens upon transfer of the asset to another user. The blockchain tokens may be transferred to a current acquiring user in exchange for the asset, thereby providing enhanced security for the blockchain tokens.

In addition, the blockchain tokens locked to the asset maintain viability of the onchain and/or offchain asset, and ensures the asset remains in force or use (e.g., does not expire, etc.). For example, the blockchain tokens may be used for renewal or other fees required to maintain the asset in force or use (e.g., maintain use of a domain, etc.). Further, the valuation of the blockchain tokens may be performed in real time to constantly or continuously update (a user interface of) the computerized platform with the real time valuation. Thus, a user may view changes of the valuation (on the user interface) in real time.

It will be appreciated that the embodiments described above and illustrated in the drawings represent only a few of the many ways of implementing embodiments for controlling transfer of staked blockchain tokens. In addition, characteristics or features of embodiments of the present invention may be combined in any fashion to provide additional embodiments of the present invention.

The environment of the present invention embodiments may include any number of computer or other processing systems (e.g., client or end-user systems, server systems, registration systems, blockchain systems, etc.) and databases or other repositories arranged in any desired fashion, where the present invention embodiments may be applied to any desired type of computing environment (e.g., cloud computing, client-server, network computing, mainframe, stand-alone systems, etc.). The computer or other processing systems employed by the present invention embodiments may be implemented by any number of any personal or other type of computer or processing system (e.g., desktop, laptop, hand-held devices, smartphones or other mobile devices, etc.), and may include any commercially available operating system and any combination of commercially available and custom software (e.g., communications software; server software; software of present invention embodiments (including management module 116, interface module 122, registration module 132, decentralized applications (dApps) 148, smart contracts 150, token smart contract 152, return smart contract 154, blockchain related applications 160, etc.); etc.). These systems may include any types of monitors and input devices (e.g., keyboard, mouse, voice recognition, etc.) to enter and/or view information.

It is to be understood that the software of the present invention embodiments (e.g., management module 116, interface module 122, registration module 132, decentralized applications (dApps) 148, smart contracts 150, token smart contract 152, return smart contract 154, blockchain related applications 160, etc.) may be implemented in any desired computer language and could be developed by one of ordinary skill in the computer arts based on the functional descriptions contained in the specification and flowcharts illustrated in the drawings. Further, any references herein of software performing various functions generally refer to computer systems or processors performing those functions under software control. The computer systems of the present invention embodiments may alternatively be implemented by any type of hardware and/or other processing circuitry.

The various functions of the computer or other processing systems may be distributed in any manner among any number of software and/or hardware modules or units, processing or computer systems and/or circuitry, where the computer or processing systems may be disposed locally or remotely of each other and communicate via any suitable communications medium (e.g., LAN, WAN, Intranet, Internet, hardwire, modem connection, wireless, etc.). For example, the functions of the present invention embodiments may be distributed in any manner among the various end-user/client, server, registration, and blockchain systems, and/or any other intermediary processing devices. The software and/or algorithms described above and illustrated in the flowcharts may be modified in any manner that accomplishes the functions described herein. In addition, the functions in the flowcharts or description may be performed in any order that accomplishes a desired operation.

The software of the present invention embodiments (e.g., management module 116, interface module 122, registration module 132, decentralized applications (dApps) 148, smart contracts 150, token smart contract 152, return smart contract 154, blockchain related applications 160, etc.) may be available on a non-transitory computer useable or readable medium (e.g., magnetic or optical mediums, magneto-optic mediums, CD-ROM, DVD, memory devices, etc.) of a stationary or portable computer program product, apparatus, or device for use with stand-alone systems or systems connected by a network or other communications medium. The computer usable or readable medium (or media) may include instructions executable by one or more processors to perform functions of present invention embodiments described herein.

The communication network may be implemented by any number of any type of communications network (e.g., LAN, WAN, Internet, Intranet, VPN, etc.). The computer or other processing systems of the present invention embodiments may include any conventional or other communications devices to communicate over the network via any conventional or other protocols. The computer or other processing systems may utilize any type of connection (e.g., wired, wireless, etc.) for access to the network. Local communication media may be implemented by any suitable communication media (e.g., local area network (LAN), hardwire, wireless link, Intranet, etc.).

The system may employ any number of any conventional or other databases, data stores or storage structures (e.g., files, databases, data structures, data or other repositories, etc.) to store information (e.g., blockchain asset information, metadata, mappings of blockchain assets to blockchains, preferences, etc.). The database system may be implemented by any conventional or other databases, data stores or storage structures to store information. The database system may be included within or coupled to the server, client, registration, and/or blockchain systems. The database systems and/or storage structures may be remote from or local to the computer or other processing systems, and may store any desired data.

The present invention embodiments may employ any number of any type of user interface (e.g., Graphical User Interface (GUI), command-line, prompt, etc.) for obtaining or providing information (e.g., valuations, notifications, domain or web site content, onchain and/or offchain asset information, etc.), where the interface may include any information arranged in any fashion. The interface may include any number of any types of input or actuation mechanisms (e.g., buttons, icons, fields, boxes, links, etc.) disposed at any locations to enter/display information and initiate desired actions via any suitable input devices (e.g., mouse, keyboard, etc.). The interface screens may include any suitable actuators (e.g., links, tabs, etc.) to navigate between the screens in any fashion.

A report may include any information arranged in any fashion, and may be configurable based on rules or other criteria to provide desired information to a user (e.g., information of onchain and/or offchain assets, offers, valuations, etc.).

The present invention embodiments are not limited to the specific tasks or algorithms described above, but may be utilized for controlling transfer of any blockchain tokens assigned to an item in exchange for the item.

An asset may include any item or object, and may be associated with a computer or network environment (e.g., a domain, a domain name, a set of records, an object that points to a set of records, a non-fungible token (NFT), non-fungible token (NFT) domain names, a fungible token, a wallet address, email or other service, communication entity, currency, stocks, equities, physical objects, virtual objects, etc.). An onchain asset may include any asset residing on, or supported by, a blockchain or other decentralized system (e.g., Web3 asset, asset of a decentralized system, asset of a partial or hybrid decentralized system, etc.). An offchain asset may include any asset residing on, or supported by, a centralized system or a system with centralized control (e.g., Web2, Domain Name System (DNS), ICANN accredited domain names, system other than a decentralized system described above, etc.). An offchain asset may further include any tangible or intangible objects maintained outside of a blockchain (e.g., currency, stocks, equities, physical objects, etc.). An onchain system may include any blockchain or other decentralized system (e.g., Web3, decentralized system, partial or hybrid decentralized system, etc.), while an offchain system may include any centralized system or system with centralized control (e.g., Web2, Domain Name System (DNS), system other than a decentralized system described above, etc.).

The name or other identifier for the offchain and onchain assets with respect to NFTs or domains may include a name portion and an optional extension (e.g., “name.e1”, etc.). Alternatively, the name or other identifier may include the name portion without the extension. The name portion and extension may each include any quantity of terms, words, tokens, or arrangements of any quantity of any types of elements (e.g., alphanumeric or other characters, symbols, numbers, etc.).

Any quantity of any parameters, values, or other information may be associated with an asset. The information for an offchain asset may include any information arranged in any fashion (e.g., values for domain records, domain parameters, server names or addresses, etc.). Any information of an offchain asset may be stored for an onchain asset to link the assets. This information may be stored on a blockchain and/or on an offchain data source in any storage item (e.g., record, data object, etc.). The information for an onchain asset may include any information arranged in any fashion (e.g., values for asset attributes, blockchain, wallet address, user/owner information etc.). Any information of an onchain asset may be stored for an offchain asset to link the assets. This information may be stored on a blockchain and/or on an offchain data source in any storage item (e.g., record, data object, etc.). The offchain data source may include any storage structure (e.g., decentralized storage structure or platform, blockchain storage, database, etc.). The asset information may be stored and retrieved based on any information (e.g., based on registered user information (e.g., wallet address, blockchain asset, blockchain domain or user name, user information, etc.)).

The onchain assets may be from any desired blockchains. Availability for an onchain asset may be determined by searching any onchain and/or offchain storage for any corresponding records or information indicating existence of the onchain asset on a system. Further, availability for an offchain asset may be determined by searching any onchain and/or offchain storage for any corresponding records or information indicating existence of the offchain asset on a system.

A name of an asset of a system may be used to access any corresponding assets of any other systems. For example, the information for the asset may indicate the information (e.g., names or identifiers, addresses, etc.) of the corresponding assets. The information may be retrieved based on the name of the asset and used to resolve the name of the asset to the location (e.g., system, name, address, etc.) of the corresponding assets on the other systems to access (and/or perform transactions) with respect to those corresponding assets. By way of example, a user may send cryptocurrency (e.g., a loan or other payment) to a Web2 domain name. Further, a user may provide an onchain domain to connect to or access an offchain account, and an offchain domain to connect to or access a wallet account.

A user may include, or be associated with, any type of entity (e.g., individual, company, organization, decentralized autonomous organization (DAO), etc.). Transfer of an onchain or offchain asset may include any action or transaction that provides ownership, rights, registration, custody, control, possession, and/or any other interest in the onchain or offchain asset. Further, an interest may include ownership, rights, registration, custody, possession, control, and/or any other stake or share in the onchain or offchain asset. Moreover, acquiring or obtaining an onchain or offchain asset may include obtaining ownership, rights, registration, custody, control, possession, and/or any other interest in the onchain or offchain asset.

The online or computerized platform may include any platform providing items for transfer. An item may include any onchain asset (e.g., non-fungible token (NFT), NFT representing an offchain asset, blockchain domain name, etc.), any offchain asset (e.g., Web2, ICANN, or Domain Name System (DNS) domain or domain name, etc.), or a combination of onchain and offchain assets (e.g., a tokenized version of an offchain domain name and the corresponding offchain domain name, etc.). An onchain asset (and offchain asset) may be obtained via any type of transaction. Any quantity of any type of onchain and/or offchain assets (e.g., cryptocurrencies, NFTs, etc.) may be assigned to an item for staking. The staking may include any desired amount or value. The staked assets may be used to cover any desired fees for the assets (e.g., renewal fees, etc.).

The valuation may be performed at any desired time intervals (e.g., periodically at any time periods, scheduled, at certain times, real time, etc.). The value of the staked blockchain tokens may be determined from any data sources (e.g., network sites, etc.). The item may be returned in any fashion (e.g., to a designated blockchain return (or wallet) address, etc.). The staked blockchain tokens may be redeemed to any entity based on any suitable conditions (e.g., redeemed to a user returning the item, etc.). Any portion of the value of the staked blockchain tokens may be transferred upon satisfaction of the conditions. Any wallet or crypto accounts of any entities (e.g., platform service provider, escrow, etc.) may be used for staking.

Any quantity of smart contracts or other modules may be used for the staking. For example, individual smart contracts may be used for staking and return, or a single smart contract may be used. Further, the staked blockchain tokens may be directly transferred, or converted to other onchain and/or offchain assets for transfer (e.g., cryptocurrency, offchain currency, etc.).

The transfer of an onchain asset may be accomplished via any blockchain or other transaction. For example, the transfer may be accomplished by conducting a transaction on the blockchain to indicate transfer of the onchain asset to a new owner. Further, transfer of an offchain asset of a computer environment may be accomplished by modifying any corresponding records of the offchain asset (e.g., Domain Name System (DNS) records, etc.). Moreover, access to the records of the offchain asset may be accomplished by modifying any corresponding records of the offchain asset (e.g., Domain Name System (DNS) records, etc.), and may be performed in response to transfer of the offchain asset.

Corresponding assets of the computer environment (e.g., onchain and corresponding offchain assets, etc.) may be the same or different types of assets, and may be on the same or different types of systems (e.g., centralized, decentralized, etc.).

Having described preferred embodiments of a new and improved system, method, and computer program product for controlling transfer of staked blockchain tokens, variations and changes will be suggested to those skilled in the art in view of the teachings set forth herein. It is therefore to be understood that all such variations, modifications and changes are believed to fall within the scope of present invention embodiments as defined by the appended claims.

What is claimed is:

1. A method of transferring items in a computer environment comprising:
acquiring for a value, via at least one processor, an item for a user from a computerized platform of the computer environment;
conducting, via the at least one processor, a first blockchain transaction to indicate acquisition of the item on a blockchain;
assigning, via the at least one processor, blockchain tokens to the item, wherein an initial valuation of the blockchain tokens corresponds to a portion of the value and a valuation of the blockchain tokens fluctuates over time;
conducting, via the at least one processor, a second blockchain transaction to indicate return of the item on the blockchain; and
controlling, via the at least one processor, transfer of the blockchain tokens based on return of the item.

2. The method of claim 1, wherein the item includes one of an onchain asset, an offchain asset, and a combination of a tokenized offchain asset and corresponding offchain asset.

3. The method of claim 2, wherein the onchain asset includes a blockchain domain and the offchain asset includes an offchain domain.

4. The method of claim 3, further comprising:
transferring, via the at least one processor, a portion of the valuation of the blockchain tokens to satisfy renewal fees for the item.

5. The method of claim 1, wherein the blockchain tokens include one or more from a group of cryptocurrency and non-fungible tokens.

6. The method of claim 1, further comprising:
transferring, via the at least one processor, the item to a different user by conducting a third blockchain transaction to indicate acquisition of the item by the different user on the blockchain; and
assigning, via the at least one processor, a right to redeem the blockchain tokens to the different user;
wherein controlling transfer of the blockchain tokens comprises:
transferring the blockchain tokens to the different user based on return of the item.

7. The method of claim 1, wherein assigning the blockchain tokens comprises:
minting the blockchain tokens with the initial valuation on the blockchain to assign to the item.

8. The method of claim 1, wherein assignment and maintenance of the blockchain tokens, return of the item, and transference of the blockchain tokens are performed by one or more smart contracts of the blockchain.

9. A system for transferring items in a computer environment comprising:
one or more memories; and
at least one processor coupled to the one or more memories, the at least one processor configured to:
acquire, for a value, an item for a user from a computerized platform of the computer environment;
conduct a first blockchain transaction to indicate acquisition of the item on a blockchain;
assign blockchain tokens to the item, wherein an initial valuation of the blockchain tokens corresponds to a portion of the value and a valuation of the blockchain tokens fluctuates over time;
conduct a second blockchain transaction to indicate return of the item on the blockchain; and
control transfer of the blockchain tokens based on return of the item.

10. The system of claim 9, wherein the item includes one of an onchain asset, an offchain asset, and a combination of a tokenized offchain asset and corresponding offchain asset.

11. The system of claim 10, wherein the onchain asset includes a blockchain domain and the offchain asset includes an offchain domain.

12. The system of claim 11, wherein the at least one processor is further configured to:
transfer a portion of the valuation of the blockchain tokens to satisfy renewal fees for the item.

13. The system of claim 9, wherein the blockchain tokens include one or more from a group of cryptocurrency and non-fungible tokens.

14. The system of claim 9, wherein the at least one processor is further configured to:
transfer the item to a different user by conducting a third blockchain transaction to indicate acquisition of the item by the different user on the blockchain; and
assign a right to redeem the blockchain tokens to the different user;
wherein controlling transfer of the blockchain tokens comprises:
transferring the blockchain tokens to the different user based on return of the item.

15. The system of claim 9, wherein assigning the blockchain tokens comprises:
minting the blockchain tokens with the initial valuation on the blockchain to assign to the item.

16. The system of claim 9, wherein assignment and maintenance of the blockchain tokens, return of the item, and transference of the blockchain tokens are performed by one or more smart contracts of the blockchain.

17. A computer program product for transferring items in a computer environment, the computer program product comprising one or more non-transitory computer readable media having instructions stored thereon, the instructions executable by at least one processor to cause the at least one processor to:
acquire, for a value, an item for a user from a computerized platform of the computer environment;
conduct a first blockchain transaction to indicate acquisition of the item on a blockchain;
assign blockchain tokens to the item, wherein an initial valuation of the blockchain tokens corresponds to a portion of the value and a valuation of the blockchain tokens fluctuates over time;
conduct a second blockchain transaction to indicate return of the item on the blockchain; and
control transfer of the blockchain tokens based on return of the item.

18. The computer program product of claim 17, wherein the item includes one of an onchain asset, an offchain asset, and a combination of a tokenized offchain asset and corresponding offchain asset.

19. The computer program product of claim 18, wherein the onchain asset includes a blockchain domain and the offchain asset includes an offchain domain.

20. The computer program product of claim 19, wherein the instructions further cause the at least one processor to:
transfer a portion of the valuation of the blockchain tokens to satisfy renewal fees for the item.

21. The computer program product of claim 17, wherein the blockchain tokens include one or more from a group of cryptocurrency and non-fungible tokens.

22. The computer program product of claim 17, wherein the instructions further cause the at least one processor to:
transfer the item to a different user by conducting a third blockchain transaction to indicate acquisition of the item by the different user on the blockchain; and
assign a right to redeem the blockchain tokens to the different user;
wherein controlling transfer of the blockchain tokens comprises:
transferring the blockchain tokens to the different user based on return of the item.

23. The computer program product of claim 17, wherein assigning the blockchain tokens comprises:
minting the blockchain tokens with the initial valuation on the blockchain to assign to the item.

24. The computer program product of claim 17, wherein assignment and maintenance of the blockchain tokens, return of the item, and transference of the blockchain tokens are performed by one or more smart contracts of the blockchain.
